(19) United States
(12) Patent Application Publication
(10) Pub. No.: US 2014/0209486 A1
(43) Pub. Date: Jul. 31, 2014

(54) DETECTING DEVICE AND METHOD APPLYING A DETECTING STRIP

(71) Applicant: ACTHERM INC, Hsinchu City (TW)

(72) Inventor: Min-Ying CHEN, Hukou Township (TW)

(73) Assignee: ACTHERM INC, Hsinchu City (TW)

(21) Appl. No.: 13/838,203

(22) Filed: Mar. 15, 2013

(30) Foreign Application Priority Data
Jan. 28, 2013 (TW) 102103222

(51) Int. Cl. G01N 27/30

(52) U.S. Cl. CPC G01N 27/307
USPC 205/793.5; 204/400; 204/435

(57) ABSTRACT

A detecting device and method applying an electrochemical detecting strip are disclosed. The detecting device is used to detect by applying an electrochemical detecting strip having at least one cavity on the upper surface thereof with the cavity being coated with reaction reagent. The detecting device is provided with an electrode assembly consisting of a plurality of electrode bodies. A working electrode and a counter electrode are disposed on the surface of each electrode body. Moreover, each electrode body is provided with an arm to be joined as a coupling port at the center of the electrode assembly such that all of the electrode bodies surround the coupling port.

### BACKGROUND OF THE INVENTION

1. Field of the Invention

The present invention is related to a detecting device and method applying an electrochemical detecting strip and more particularly related to a detecting device provided with a disposable detecting electrode set.

2. Description of the Prior Art

Biosensor is an apparatus converting the biological signal to be electrical signal by implementing a sensitive biological element and a transducer. The biosensor can be an electrochemical biosensor, an Ion Sensitive Field Effect Transistor (ISFET), a Fiber-Optic Biosensor, a Piezoelectric Quartz Crystal Biosensor in accordance with the usage of the different transducer. The Electrochemical Biosensor was the first one to be developed and has been used in many different fluid bodies detecting, such as detectors in a lab or professional detecting lab, Pesticide residues detector, or Home medical application detector (such as blood sugar, uric acid or cholesterol detector and so on).

The basic structure of the electrochemical biosensor or electrochemical strip includes three portions: 1. a receiving area for under test fluid; 2. a detecting reagent, which can be a strip for chemical material, enzymes or antibody; 3. a plurality of detectable electrodes, such as reference electrode, working electrode, counter electrode or detecting electrode. The common home medical detecting machine only includes two detecting electrodes, which are a counter electrode and a working electrode, or a reference electrode and a working electrode, moreover the detecting machine can include three electrodes, which are a working electrode, a reference electrode and a counter electrode and the number of the electrodes is based on the requirement of the electrochemical reaction.

The present electrochemical strip usually implements printing and adhesive technique to stack the electrode with the non-conductive material of the detecting strip or directly implements printing technique to print the electrode on the non-conductive material and coat the detecting strip on the electrode to be the detecting strip. When the testing fluid is reacted with the detecting strip, the electrons generated by the reaction are accumulated on the surface of the electrode and a detecting machine will provide a constant voltage thereof to calculate the number of electrons accumulated on the surface of the electrode. The current value of the detecting result is calculated by the converting formula included in the machine to obtain the main reacting concentration and the value thereof is displayed on the monitor of the machine for everyone to know the detecting result.

However, in the detecting strip formed by the description above, the manufacture of the detecting strip would be affected by the electrode process, for example the electrode formed by printing is required to wait for the dry time of the ink and then to do the coating of the detecting strip, so the cost of time is increased. Moreover, the detecting strip formed by stacking includes multiple layers structure, such as an isolated substrate, a conductive thin film electrode and so on, so the manufacture cost is increased. Especially, the electrode is contacted with the detecting strip before detecting and the electrode would be etched by the detecting strip to cause some drawbacks, such as the detecting error or detecting strip wasting. Therefore, how to cost down, how to avoid the effect of the electrode process during the manufacture of the detecting strip and how to make sure that the electrode is not etched by the detecting strip before using to reduce the waste caused by the damage of the detecting strip are the problems request to be solve by a person with ordinary skill in the art.

### SUMMARY OF THE INVENTION

Accordingly, the object of the present invention is to provide specially designed detecting electrodes of a detecting device applying a detecting strip to prevent the detecting electrodes from contacting with the detecting strip before detecting to reduce the risk of the etching of the detecting reagent and decrease the damage of the detecting strip and manufacture consumption.

Another object of the present invention is to provide detecting electrodes for a detecting device applying a detecting strip with the detecting electrodes being disposable and detachable when installing in the detecting device.

Another object of the present invention is to provide detecting electrodes for a detecting device applying a detecting strip with the electrodes being made in a different process from the one for the detecting strip and the manufacture of the detecting strip not being affected by the manufacture of the electrodes.

Another object of the present invention is to provide detecting electrodes for a detecting device applying a detecting strip with the electrodes being made by an accuracy manufacture technique, such as laser etching technique to provide high accuracy and low cost electrodes.

Another object of the present invention is to provide a detecting method applying a detecting strip and detecting electrodes, in which the detecting strip and the detecting electrodes are separated when not in use but contacted to each other when in use.

According to objects above, a detecting device applying a detecting strip is disclosed in the present invention and configured to detect the detecting strip with a reacting concave disposed thereon, the reacting concave being coated with a detecting reagent and the detecting device including a detecting electrode set formed by a plurality of electrode bodies, each of the electrode bodies including a first electrode and a second electrode and connected to a supporting arm, all of the supporting arms connected together at a central position of the detecting electrode set and formed a connective portion, the electrode bodies sequentially circled around the connective portion, the electrode set disposed on the detecting device by the connective portion; wherein each of the electrode bodies of the detecting electrode set is in turn coupled to the reacting concave of the detecting strip, and disposed on a top of the reacting concave of the detecting strip with the first electrode and the second electrode facing the reacting concave.

A detecting method applying a detecting strip is disclosed in the present invention and includes steps of: providing a detecting strip formed with a reacting concave on surface, the reacting concave coated with a detecting reagent; providing a detecting device to read a reacting signal from the detecting strip; providing a detecting electrode set formed by a plurality of electrode bodies, one surface of each of the electrode bodies including a first electrode and a second electrode, each of the electrode bodies being connected to a supporting aim and all of the supporting arms connected together at a central position of the detecting electrode and formed a connective portion, and disposing the detecting electrode on the detecting device by the connective portion; injecting a testing fluid into the reacting concave of the detecting strip to incur reaction of the testing fluid with the detecting reagent; and putting the detecting strip in the detecting device, disposing one of the electrode bodies of the detecting electrode set on a top of the reacting concave of the detecting strip and allowing the first electrode and the second electrode to face the reacting concave.

The advantages in the present invention are: 1. the detecting electrodes won't be contacted with the detecting reagent of the detecting strip before starting a testing to reduce the risk of the etching by the detecting strip so as to decrease the cost caused by damage. 2. The detecting electrodes are made in a different process from the one for the detecting strip and the manufacture of the detecting strip won't be affected by the manufacture of the detecting electrode. 3. The detecting electrodes are made by high accuracy manufacture technique, such as laser etching manufacture to produce high accuracy and low cost electrode. 4. The detecting electrodes are disposable, detachable when installing in the detecting device.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is a structural view schematically illustrating a detecting device applying a detecting strip and a detecting electrode set of the detecting device according to a first embodiment of the present invention;

FIG. 1B is a structural view schematically illustrating a status of combining an electrode body of the detecting electrode set of the detecting device with a detecting strip according to the first embodiment of the present invention;

FIG. 1C is a cross-sectional side view along A-A line of FIG. 1B illustrating the combination relationship of the electrode body and the detecting strip according to the first embodiment of the present invention;

FIG. 2 is a structural view schematically illustrating a detecting device applying a detecting strip and a detecting electrode set of the detecting device according to a second embodiment of the present invention;

FIG. 3 is a structural view schematically illustrating the detecting electrode set according to the first embodiment of the present invention;

FIG. 4A to FIG. 4F are structural views schematically illustrating various shapes for each of the electrode bodies in the detecting device according to various embodiments of the present invention ; and

FIG. 5 is a flow chart illustrating a detecting method applying a detecting strip.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

A detecting electrode set for a detecting strip and a detecting device with the detecting electrode set are disclosed in the present invention. The advantage is that the detecting electrode set won't be contacted with the detecting reagent of the detecting strip before testing to reduce the risk of etching the detecting strip and decrease the cost by the damage of the detecting strip. In addition, the detecting electrode set is made by a different process and won't affect the manufacturing process of the detecting strip. The electrode of the detecting electrode set can be made by a precision technology, such as laser etching, to provide an electrode with high accuracy and low cost. The electrode is detachable and disposable and can be arbitrarily installed on the detecting device or detach from the detecting device.

The following definition is to clarify the meaning of the terms using in the description.

The term “working electrode” or other similar term is that a significant change occurred in the concentration of the reagent object when a larger current passing. According to the reaction of the electrode, the electrode can be anode or cathode. When the electrode is in the oxidation reaction, it is anode; when the electrode is in the reduction reaction, it is cathode.

The term “counter electrode” or other similar term is formed a loop with the working electrode. It is used to study the polarization of the electrode when the current is passing. When the working electrode is cathode, the reference electrode is anode. When the working electrode is anode, the reference electrode is cathode.

The term “reference electrode” or other similar term is to state that the electrical level of the electrode is stable and reproducibility. The electrical level of other electrode is detected in accordance with the standard of the reference electrode. It is used to provide a standard electrical level and the electrical level will be not changed by the different detecting system and the variation of the concentration to vary the electrode. The common reference electrode is hydrogen electrode, calomel electrode, Ag/AgCl electrode or Hg/Hg₂Cl₂ electrode. The calomel electrode is most common use.

The term “etching technique” or other similar term is to remove a chemical material by a chemical reaction or physical combat. The etching technique can be wet etching or dry etching.

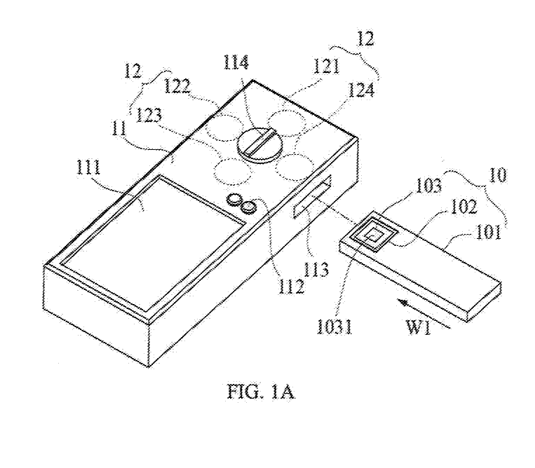

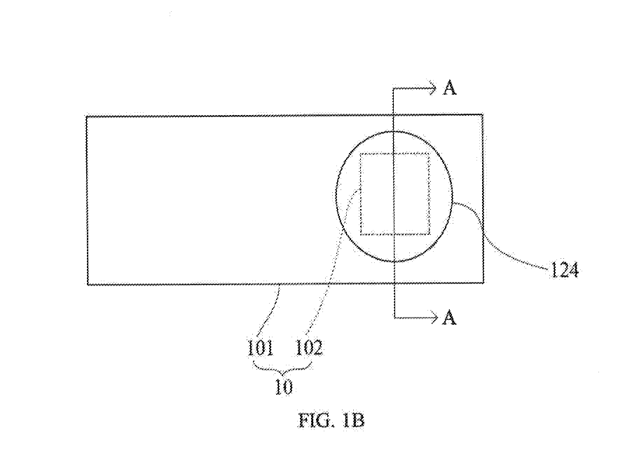

Please refer to FIG. 1A, which is a view illustrating a detecting device 11 applying a detecting strip 10 in a first embodiment of the present invention. The detecting device 11 includes a detecting electrode set 12. Please refer to FIG. 1A to FIG. 1C, the detecting strip is formed by an isolated plate 101 and includes at least one reacting concave disposed on a top surface thereof. A detecting reagent 103 is coated within the reacting concave 102 and can be a chemical, enzyme or antibody reagent in accordance with the property of the testing fluid. When the testing fluid is injected into the reacting concave 102 and reacted with the detecting strip 103 to form a compound 1031. The detecting strip 103 is transferred to the detecting device 11 to do an analysis according to the transfer direction W1.

The detecting device 11 includes a function to read and analysis a reacting signal of the compound 1031 of the detecting strip 10 so as to generate an analysis result. So the detecting device can be a portable detecting machine, a portable electronic device, an electronic calculator, computer, desktop or so on. The detecting device 11 in the present embodiment is a portable detecting machine. The detecting device 11 includes a monitor 111 to display the detecting result, a button 112 to operate the machine, and a transfer component 113 to contain the detecting strip 10. The characteristic of the detecting device 11 is to includes a detecting electrode set 12, which is made of a plurality of electrode bodies 121, 122, 123 and 124 and the detecting device 11 includes a swivel plate 114 configured for the user to switch the electrode bodies 121, 122, 123 and 124. The detecting electrode set 12 is a detachable device and the four electrode bodies 121, 122, 123 and 124 can be detached after using to renew the new detecting electrode set 12. For example, when the detecting strip 10 is entered to the detecting device 11 by the transfer component 113, the compound 1031 within the reacting concave 102 is entered to the machine to combine with the electrode body 124 and the combine status is shown in FIG. 1B. The electrons generated by the compound 1031 will be accumulated on the surface of the electrode body 124. Then, a constant voltage is provided by the detecting device 11 to detect the number of the accumulated electrodes on the surface of the electrode body 124. The detecting current is calculated by the formula built in the detecting device 11 to obtain the main reaction concentration and the value thereof is displayed on the monitor 111 of the detecting device 11 for the user to know the detecting result. FIG. 1C is a sectional view illustrating the detecting strip 10 connected to the electrode body 124 of the detecting electrode set of the detecting device in one embodiment of the present invention. The electrode body 124 includes a counter electrode 1241 and a working electrode 1242. The counter electrode 1241 and the working electrode 1242 are contacted with the compound 1031.

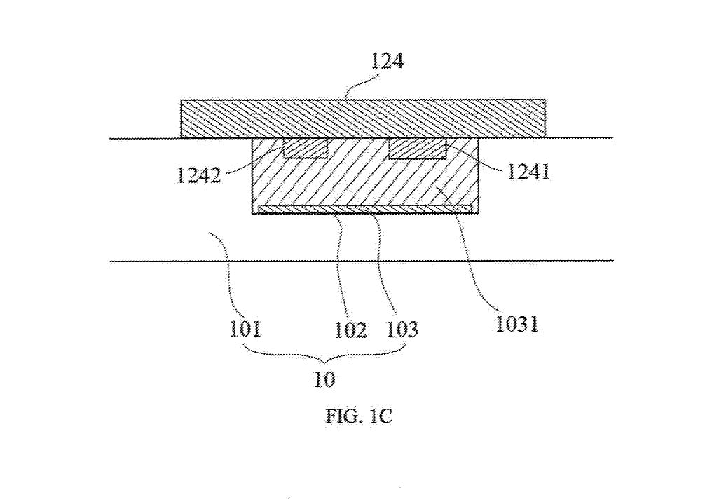

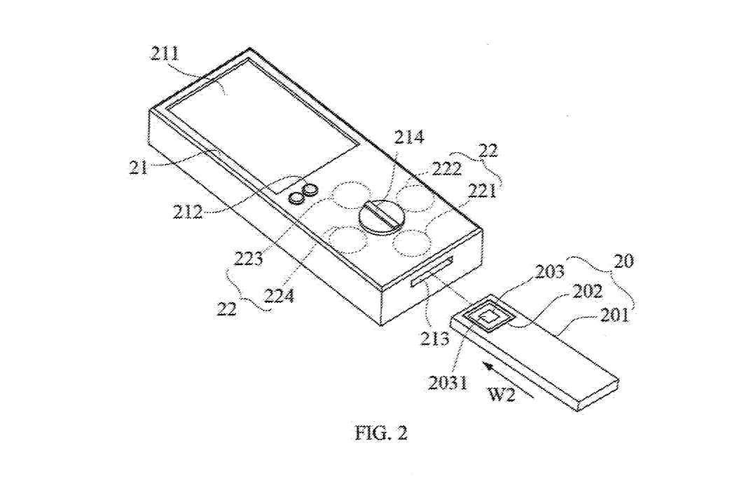

Please refer to FIG. 2, which is a view illustrating the detecting device 21 applying the detecting strip in a second embodiment of the present invention. The detecting strip 20 is made by an isolated plate 201 and includes a reacting concave 202 disposed on the top surface thereof. The detecting reagent 203 is coated within the reacting concave 202 and the detecting reagent 203 can be chemical, enzyme or antibody reagent according to the property of the testing fluid. When the testing fluid is injected into the reacting concave 202 and reacted with the detecting strip 203 to form a compound 2031. The detecting strip 203 is transferred to the detecting device 21 to do an analysis according to the transfer direction W2. The detecting device 21 includes a monitor 211 to display the detecting result, a button 212 to operate the machine, and a transfer component 213 to contain the detecting strip 10. The characteristic of the detecting device 21 is to include a detecting electrode set 22, which is made of a plurality of electrode bodies connected together to be a swivel plate electrode set. The electrode set 22 in the present embodiment includes 4 electrode bodies 221, 222, 223 and 224 and the detecting device 21 includes a swivel plate 214 configured for the user to switch the electrode bodies 221, 222, 223 and 224. The detecting electrode set 22 is a detachable device and the four electrode bodies 221, 222, 223 and 224 can be detached after using to renew the new detecting electrode set 22. When an open of the transfer component 213 of the detecting device 21 is disposed close to the electrode 221 and the transfer direction W2 and the detecting device 21 are in parallel, which is different to the transfer direction W1 vertical to the detecting device shown in FIG. 1A. In addition, the connection of the detecting strip 20 and the electrode 221 and the generation of the analysis result are described in the previous chapter and the detail description thereof is omitted herein.

FIG. 3 is a view illustrating the detecting electrode set of the detecting device applying the detecting strip in one embodiment of the present invention. The detecting electrode set 3 is a swivel plate electrode set made by a plurality of the electrode bodies 33 and each of the electrode bodies is connected to the other by a supporting arm and the central position of the connection is formed to be a connective portion 31. The electrode bodies 33 can be connected to the detecting device 11 and 21. The shape of the electrode body is a circle or polygon and includes a working electrode, a counter electrode, a reference electrode and a detecting electrode in accordance with the different requirement of the electrochemical reaction. For example, the common sugar detecting strip can only include two electrodes, which are a counter electrode, and a working electrode or a reference electrode and a working electrode, or includes three electrodes at the same time, such as a counter electrode, a working electrode and a reference electrode.

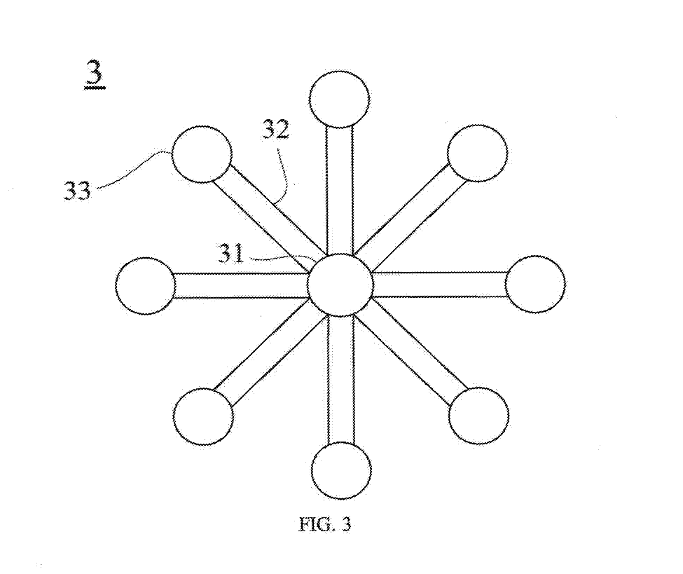

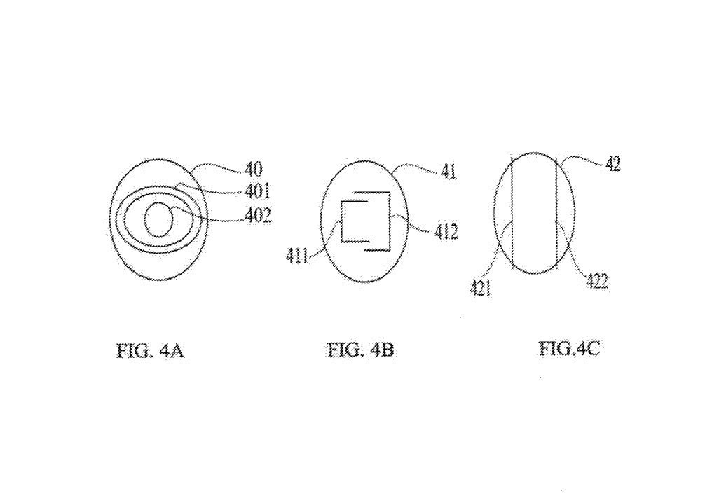

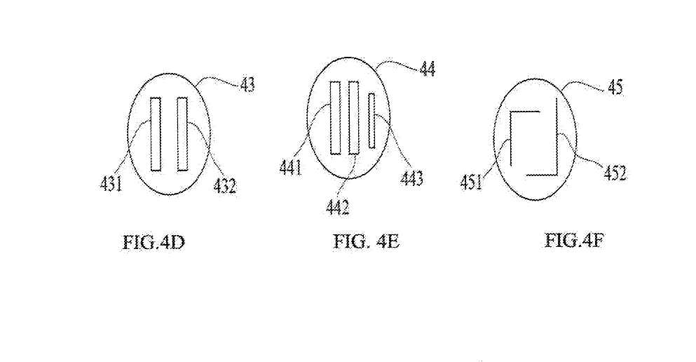

Please refer to FIG. 4A to FIG. 4F. Each of the electrodes in an electrode body in the detecting device of the embodiment of the present invention can be a concentric circle shape, a reverse U shape, linear shape, a horizontal rectangular shape or L shape and preferred to be a concentric circle shape. For example, the working electrode 401 of the electrode body is of a solid circular shape and the reference electrode is of a circular ring shape. The working electrode 411 of the electrode body 41 is a reverse U shape and so is the counter electrode. The working electrode 421 and the counter electrode of the electrode body 42 are linear; the working electrode 431 and the counter electrode 432 of the electrode body are rectangular; the working electrode 441, the counter electrode 432 and the reference electrode 443 are rectangular; the working electrode 451 and the counter electrode 442 of the electrode body are rectangular; the working electrode 451 and the counter electrode 452 of the electrode body 45 is a L shape. However, the shape of the working electrode, the counter electrode or the reference electrode of the electrode body of the detecting device for the detecting strip in the present invention is not limited herein.

Moreover, each of the electrode bodies in the detecting electrode set 3 is conductive material made by a single metal or a combination with some specific metals, so the back side of the electrode can be formed by etching method. The forming method can produce an electrode with high accuracy and low cost. The process of the detecting electrode set and the process of the detecting strip are separated, so the process of the detecting strip won't be affected by the process of the detecting electrode set.

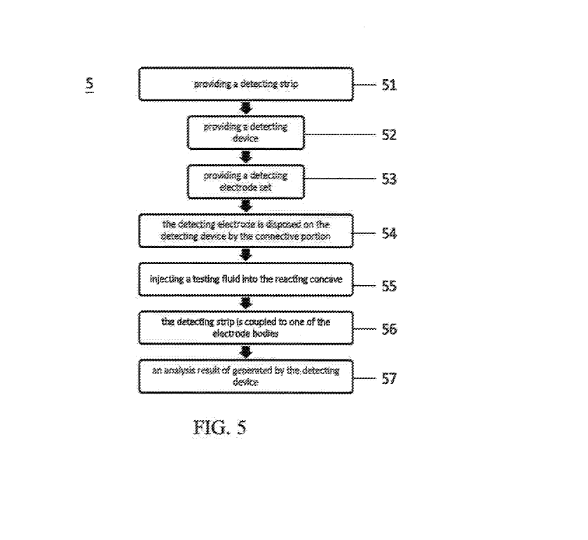

Moreover, a detecting method applying a detecting strip is provided in the present invention. Please refer to FIG. 5, it includes steps 51 to 57 and the detail description thereof is described at the following. Step 51, it is to provide a detecting strip 10, 20 and a surface thereof including a reacting concave 102, 202 and the reacting concave 102, 202 is coated with a detecting reagent 103, 203, which can be a chemical, enzyme or antibody. In step 52, it is to provide a detecting device 11, 21 to read a reacting signal of the detecting strip 10, 20 so as to generate a detecting result. According to the usage requirement, the detecting device 11, 21 can be a portable detecting machine, a portable electrical machine, an electrical calculator, a desktop and so on. In step 53, it is to provide a detecting electrode set 12, 22 formed by a plurality of electrode bodies and each of the electrode bodies is connected to the other by a supporting art to form a swivel plate combination. The connective points at the central position of the swivel plate combination to form a connective portion 33. The detecting electrode set 12, 22 is disposed on the detecting device 11, 21 by the connective portion 33. In addition, the detecting device 11, 12 includes a swivel plate 114, 214 for the user to choose the electrode bodies 121, 122, 123, 124, 221, 222, 223 or 224. In step 54, after connecting the detecting device 11, 21 and the detecting electrode set 12, 22 together, the detecting device with a detecting electrode set is provided. In step 55, it is to inject a testing fluid into the reacting concave 102, 202 of the detecting strip 10, 20 to react with the detecting reagent 103, 203. The testing fluid and the detecting strip 103, 203 are formed to be a compound 1031, 2031. In step 56, the detecting strip 10, 20 is coupled to one of the electrode bodies 121, 122, 123, 124, 221, 222, 223 or 224 of the detecting electrode set 12, 22 on the detecting device 11, 21. In step 57, an analysis result of a chemical reaction generated by the detecting device 11, 21.

Accordingly, the advantages in the present invention are: 1. the detecting electrode won't be contacted with the detecting reagent of the detecting strip before testing to reduce the risk of the etching by the detecting strip so as to decrease the damaged cost. 2. The detecting electrodes are made in a different process and the manufacture of the detecting strip won't be affected by the manufacture of the detecting electrodes. 3. The detecting electrodes are made by high accuracy manufacture technique, such as laser etching manufacture to produce high accuracy and low cost electrode. 4. The detecting electrodes are disposable, detachable when installing in the detecting device.

Although specific embodiments have been illustrated and described, it will be appreciated by those skilled in the art that various modifications may be made without departing from the scope of the present invention, which is intended to be limited solely by the appended claims.

What is claimed is:

1. A detecting device applying a detecting strip with a reacting concave disposed thereon, the reacting concave being coated with a detecting reagent, the detecting device comprising:
a detecting electrode set formed by a plurality of electrode bodies, each of the electrode bodies including a first electrode and a second electrode and being connected to a supporting arm, all of the supporting arms connected together at a central position of the detecting electrode set and formed a connective portion, the electrode bodies sequentially circling around the connective portion, the detecting electrode set disposed on the detecting device by the connective portion;
wherein each of the electrode bodies of the detecting electrode set is in turn coupled to the reacting concave of the detecting strip and disposed on a top of the reacting concave of the detecting strip with the first electrode and the second electrode facing the reacting concave.

2. The detecting device of claim 1, wherein each of the electrode bodies of the detecting electrode set is made of electrically conductive material.

3. The detecting device of claim 1, wherein each of the electrode bodies of the detecting electrode set is of a shape selected from the group consisting of a circle and a polygon.

4. The detecting device of claim 1, wherein the first electrode is one electrode selected from the group consisting of a reference electrode, a counter electrode, a working electrode and a detecting electrode.

5. The detecting device of claim 1, wherein the first electrode is of a circular shape and the second electrode is of a circular ring shape.

6. The detecting device for the detecting strip of claim 1, wherein a shape of the first electrode is one selected from the group consisting of a linear shape, a rectangular shape, a reverse U shape and an L shape.

7. A detecting method applying a detecting strip, comprising steps of:
providing a detecting strip fanned with a reacting concave on surface, the reacting concave coated with a detecting reagent;
providing a detecting device to read a reacting signal from the detecting strip;
providing a detecting electrode set formed by a plurality of electrode bodies, one surface of each of the electrode bodies including a first electrode and a second electrode, each of the electrode bodies being connected to a supporting arm and all of the supporting arms connected together at a central position of the detecting electrode and formed a connective portion, and disposing the detecting electrode on the detecting device by the connective portion;
injecting a testing fluid into the reacting concave of the detecting strip to incur reaction of the testing fluid with the detecting reagent; and
putting the detecting strip in the detecting device, disposing one of the electrode bodies of the detecting electrode set on a top of the reacting concave of the detecting strip and allowing the first electrode and the second electrode to face the reacting concave.

8. The detecting method of claim 7, wherein the step of putting the detecting strip in the detecting device is performed in a manner that the detecting strip is parallel to the detecting device.

9. The detecting method of claim 7, wherein the step of putting the detecting strip in the detecting device is performed in a manner that the detecting strip is perpendicular to the detecting device.
